(19) United States
(12) Patent Application Publication
(10) Pub. No.: US 2007/0143579 A1
(43) Pub. Date: Jun. 21, 2007

(54) Integrated data processor

(75) Inventors: Yang-Ming Shih, Hsinchu (TW); Pei-Liang Kung, Taipei (TW)

Correspondence Address: BACON & THOMAS, PLLC, 625 SLATERS LANE, FOURTH FLOOR, ALEXANDRIA, VA, 22314, US

(73) Assignee: King Billion Electronics Co. Ltd., Chupei City (TW)

(21) Appl. No.: 11/303,962

(22) Filed: Dec. 19, 2005

(51) Int. Cl. G06F 9/30

(52) U.S. Cl. 712/200

(57) ABSTRACT

An integrated data processor of the present invention integrates a plurality of functions of a digital signal processor (DSP) and a microprocessor control unit (MCU). A plurality of novel instructions and pipeline parallelism architecture are applied. A pipeline parallelism intends to have read/write actions executed in different stages, so as to complete executing an instruction in a single cycle. An operand can be fetched from a RAM, and a calculation result can be written back to the RAM, so as to enhance operation efficiency of the processor.

### BACKGROUND OF THE INVENTION

1. Field of the Invention

The invention relates in general to a data processor, and more particularly to an integrated data processor, which integrates a plurality of functions of a digital signal processor (DSP) and a microprocessor control unit (MCU).

2. Description of the Related Art

In conventional operating systems concerning a digital signal processor (DSP), most architecture makes use of an independent microprocessor control unit (MCU) to co-operate with an independent digital signal processor to operate in a manner of co-processor. The DSP is generally used as a co-processor to assist the MCU to perform data processing. While the MCU sends out a DSP instruction to control the DSP to execute data operation, the MCU itself also executes its own instruction simultaneously.

In terms of tasks of the MCU and the DSP, the MCU usually works as a controller such as processing interrupts, receiving bit-stream data, and so on. Those received data can be further transferred to the DSP to perform further operations.

However, it is found that the hardware cost of the above-mentioned two independent processors is rather high. Each independent processor further includes respective built-in detailed units, such as an instruction decoder, an operand fetch unit, a calculation unit, and a storage unit. An interface of a data transfer/communication channel between the MCU and the DSP is also required. Therefore, in view of the hardware architecture of the conventional system, a bottleneck exists in reducing the hardware cost.

### SUMMARY OF THE INVENTION

The present invention provides an integrated data processor, which can support MCU and DSP functions. The integrated data processor of the present invention ensures high performance in data operation efficiency, and also can reduce hardware cost with a system architecture design of the present design.

To achieve an objective of the present invention, the integrated data processor includes an arithmetic unit, an advanced memory parallelism bus (AMPB), and a Y address generator.

The arithmetic unit works as a core unit for performing data calculation. The arithmetic unit is connected to a common data bus and a Y data bus. The common data bus is connected to an X address generator, a data fetch unit and a register unit. Moreover, the Y data bus is connected to an internal Y RAM.

The advanced memory parallelism bus (AMPB) is connected to the data fetch unit and an instruction fetch unit. The AMPB is connected to an internal program ROM/FLASH, an internal X RAM, an external ROM/RAM and a plurality of peripheral devices. The AMPB can use a pipeline operation manner to synchronously process data transmission and fetch an instruction to enhance a parallel operation. Besides, the AMPB further includes a data transfer unit and an interrupt controller. The interrupt controller takes charge to handle operations when an interrupt is requested.

The Y address generator is connected to the register unit and the internal Y RAM.

With the above-mentioned architecture of the present invention, the processor cooperating with a novel instruction set can efficiently execute data computation and instruction operation.

### BRIEF DESCRIPTION OF THE DRAWING

FIG. 1 shows an architecture diagram of the present invention.

FIG. 2 shows an allocation table of a RAM of the present invention.

FIG. 3 shows a program-addressing diagram of the present invention.

FIG. 4 shows a data-addressing diagram of the present invention.

FIG. 5 shows an allocation table of a plurality of registers of the present invention.

FIG. 6 shows an allocation table for the registers of a byte-access function of the present invention

FIG. 7A shows an allocation table of a system option control register (SOCR) of the present invention.

FIG. 7B shows an allocation table of a program status register (PSR) of the present invention.

FIG. 7C shows an allocation table of a stack overflow/underflow register (STOVUN) of the present invention.

FIG. 8 shows a circuit block diagram of a multiply-and-accumulate (MAC) unit of the present invention.

FIG. 9 shows a relation-mapping table of addressing modes and addressing ranges of the present invention.

FIG. 10 shows a relation-mapping table of three addressing modes and addressing generators of the present invention.

FIG. 11 shows a diagram of a barrel shifter of the present invention.

FIG. 12 shows a table of a plurality of interrupt control registers (xxICR) of the present invention.

FIG. 13 shows a table of addresses of interrupt-control registers and interrupt-vectors of the present invention.

FIG. 14 shows a table of exceptions supported by the present invention.

FIG. 15 shows a table of an exception register (EXR) of the present invention.

FIG. 16 shows a table of a data transfer unit-control register (DTUCx) of the present invention.

FIG. 17 shows a contrast table of an INC field of the data transfer unit-control register (DTUCx) of the present invention.

FIG. 18 shows an address vs. pointer table used by the data transfer unit of the present invention.

FIG. 19 shows a table of an external memory control register (EMCR) of the present invention.

FIG. 20 shows a diagram of an external memory space of the present invention.

FIG. 21 shows a table of a clock control register (CLKCON) of the present invention.

FIG. 22 shows a system clock table that the clock control register (CLKCON) can set in the present invention.

FIG. 23 shows a structure block diagram of a timer of the present invention.

FIG. 24 shows a table of a time base control register (TBC) of the present invention.

FIG. 25 shows a time base clock frequency table that the time-base control register (TBC) can set in the present invention.

FIG. 26 shows a diagram of a pipeline operation of the present invention.

FIG. 27 shows a table of a pipeline operation of an unconditional transfer instruction of the present invention.

FIG. 28 shows a table of the pipeline operation of a conditional transfer instruction of the present invention when executing a transfer action.

FIG. 29 shows a table of the pipeline operation of the conditional transfer instruction of the present invention when not executing a transfer action.

### DETAILED DESCRIPTION OF THE INVENTION

An innovated integrated data processor is provided, which integrates a plurality of functions of a digital signal processor (DSP) and a microprocessor control unit (MCU). A plurality of instructions and a pipeline-process architecture are applied in the present invention, so that a single instruction execution can be completed in a single cycle. An operand can be fetched from a RAM, and a calculation result can be written back to a RAM, so as to greatly enhance operation efficiency of the whole system.

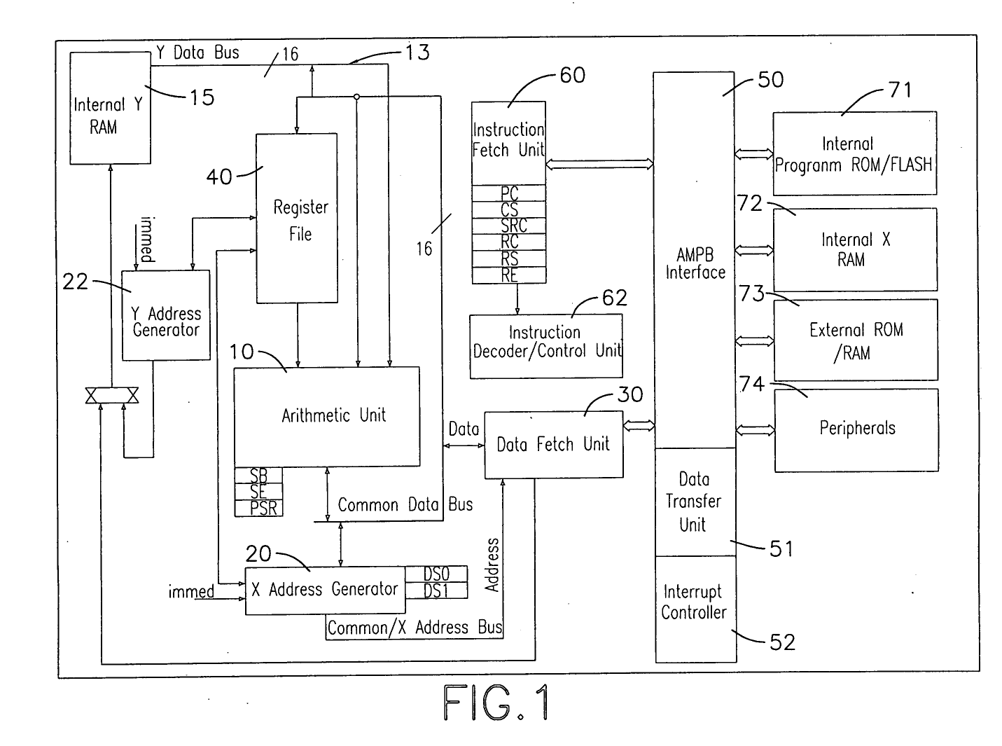

Referring to FIG. 1, a detailed circuit diagram of the present invention is shown. An arithmetic unit 10 works as a core unit for performing data calculation, such as normal arithmetic computation like add, subtract, multiply, divide, logic operations like and, or, xor, shift/rotate operations, and DSP operations like MAC operations.

The arithmetic unit 10 is connected to an X address generator 20 by a common data bus 11, a data fetch unit 30 and a register unit 40. The arithmetic unit 10 is further connected to an internal YRAM 15 by a Y data bus 13.

An advanced memory parallelism bus (AMPB) 50 includes a data transfer unit 51 and an interrupt controller 52. The AMPB 50 is connected to the data fetch unit 30 and an instruction fetch unit 60. The AMPB 50 can access data via an internal program ROM/FLASH 71, an internal XRAM 72, an external ROM/RAM 73 and a plurality of peripheral devices 74.

A Y address generator 22 is connected to the register unit 40 and the internal YRAM 15.

The instruction fetch unit 60 can fetch instructions from the internal program ROM/FLASH 71, the internal XRAM 72, and the external ROM/RAM via an advanced memory parallelism bus 50. Simultaneously, the data fetch unit 30 also can fetch operand data from any of the RAMs via the advanced memory parallelism bus 50. Hence, when fetching the instructions and data, the advanced memory parallelism bus 50 works to control a data access path, to determine access priority and switch. The advanced memory parallelism bus 50 includes an important feature of being able to fetch the instructions and the data simultaneously, which enhances a parallel operation of the processor.

The instruction fetch unit 60 is further connected with an instruction decoder/control unit 62. The instruction decoder/control unit 62 decodes a coded instruction fetched by the instruction fetch unit 62 and generates a pipeline control instruction.

The present invention uses a set of address RAMs, which are the internal XRAM 72 and the internal YRAM 15. The arithmetic unit 10 can fetch two operands from the internal XRAM 72 and the internal YRAM 15 within a cycle to provide for a multiply-and-accumulate (MAC) calculation. An MAC operation can read one operand from XRAM and another operand from YRAM in parallel, multiply them and accumulate with an AR (accumulator) register.

The X address generator 20 and the Y address generator 22 can generate two addresses simultaneously, so as to provide for the MAC calculation. Moreover, the single X address generator 20 can provide an address instruction for a general MCU operation, which is a 24-bit address for addressing any of the above-mentioned RAMs. This addressing manner for the RAMs of the present invention also can be applied for addressing a register and special function registers.

The X address generator 20 can execute two special functions: one is a circular buffer function, which is very helpful to DSP algorithm, and the other one is a Bit reversal function. On the other hand, the Y address generator 22 also includes the circular buffer function. However, only the X address generator 20 provides the Bit reversal function.

The register unit 40 includes a plurality of general-purpose registers R0˜R4, a plurality of accumulator registers (AR) ARX, ARH and ARL, a plurality of index registers X0˜X2 and Y0˜Y2, a frame pointer and a stack pointer.

The foresaid description provides a brief illustration of the present invention. A detailed introduction of each part of the present invention is as follows.

First: Memory:

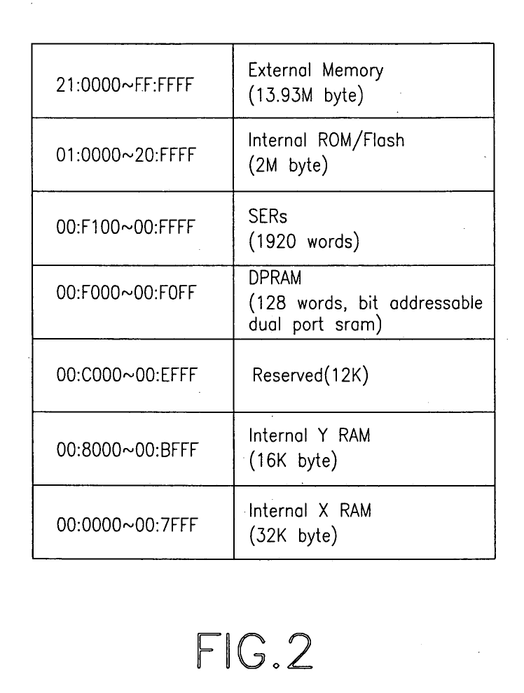

Referring to FIG. 2, an allocation table of a RAM of the present invention is shown. A minimum memory capacity provided in the present invention is 16 MB bytes. In a ROM/Flash mode, a reset address and an interrupt vector are stored in the internal program ROM/FLASH 71. On the other hand, in a ROM-less mode, the reset address and the interrupt vector start from the external ROM/RAM 73.

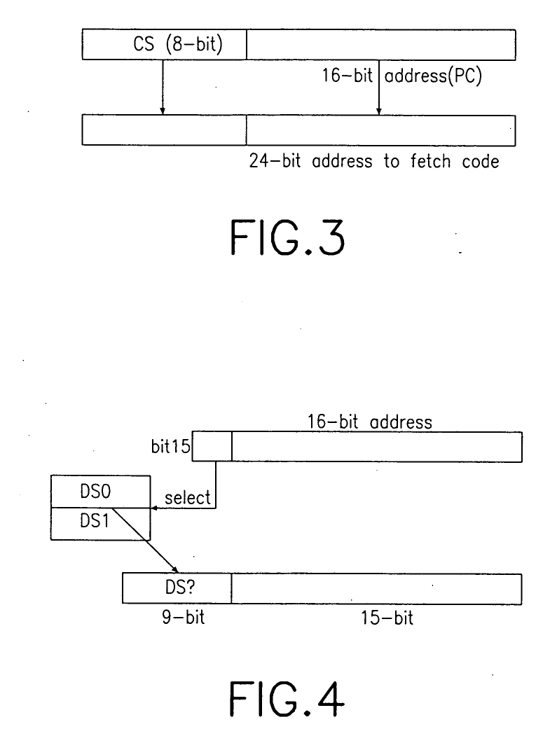

Program addressing: the present invention can execute programs in the internal program ROM/FLASH 71, the internal XRAM 72, and the external ROM/RAM 73, but cannot execute programs in the internal YRAM 15. Addressing spaces for program codes and data are the same, which are 24-bit addresses. Referring to FIG. 3, a program-addressing diagram of the present invention is shown. The present invention is a 16-bit processor. A program counter (PC) of the present invention is also only the 16-bit program counter. Hence an 8-bit code segment (CS) register is used to concatenate the program counter, so as to compose a complete 24-bit address data.

Data addressing: referring to FIG. 4, the present invention can use two methods to access data in the RAMs, which are a direct access mode and an indirect access mode. These two modes are both 16-bit addressing, so that both modes need to use 9-bit DS0 or DS1 registers to concatenate the 16-bit addressing to compose a complete 24-bit data address. The highest bit, which is bit-15 of the 16-bit addressing, can determine whether to use the DS0 or DS1 registers.

Second: Registers:

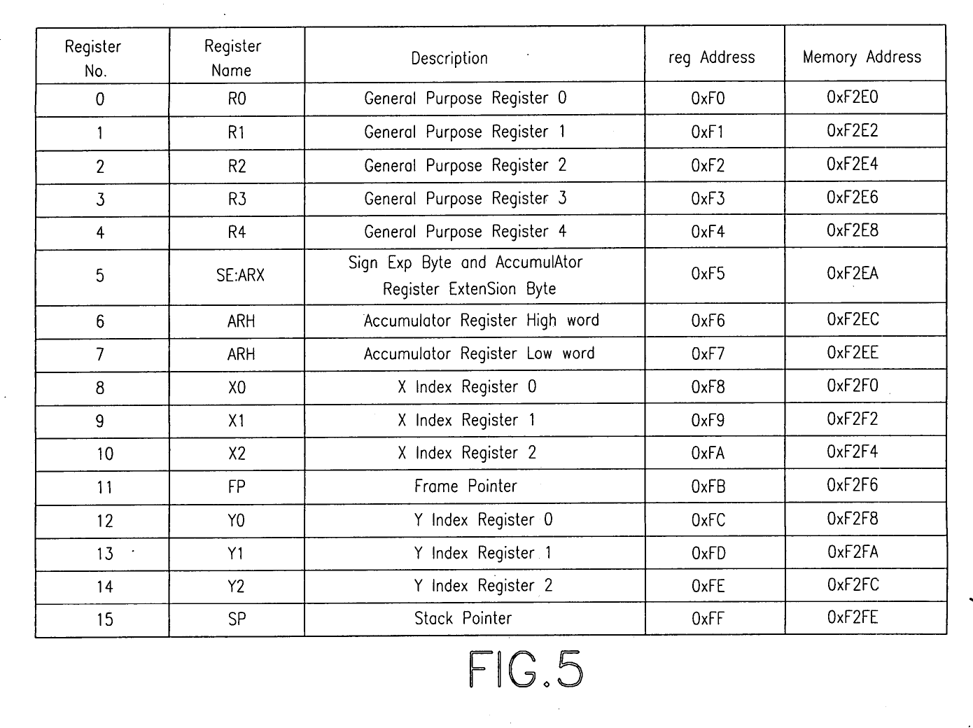

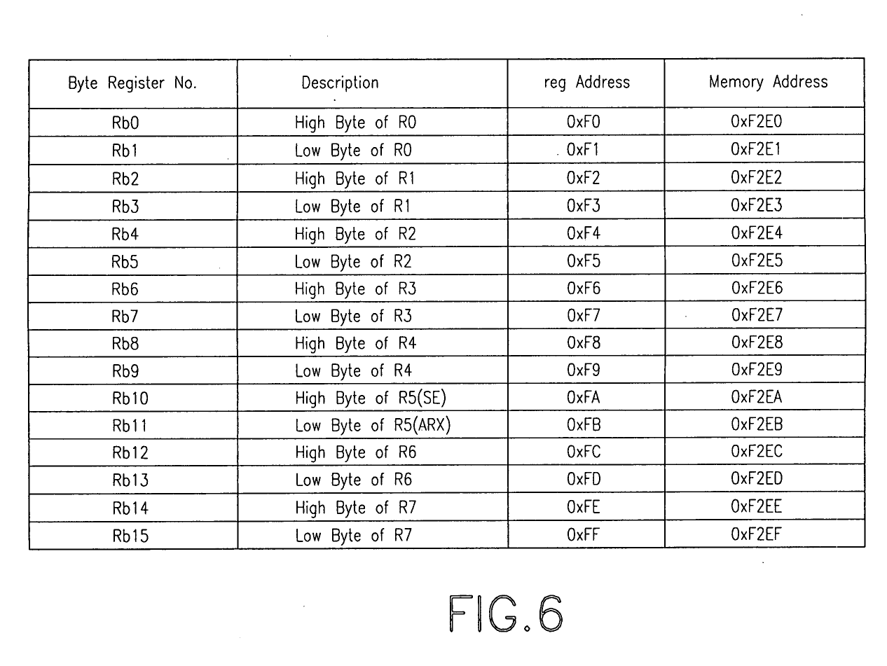

Referring to FIG. 5, an allocation table of a plurality of registers of the present invention is shown. The registers include a plurality of general-purpose registers R0˜R4, a plurality of accumulator registers ARX, ARH and ARL, a plurality of index registers X0˜X2 and Y0˜Y2, a frame pointer FP and a stack pointer SP. The registers are all 16-words registers.

The foresaid three accumulator registers ARX, ARH and ARL can be used as 40-bit accumulators in multiply and accumulate (MAC) instructions. Moreover, if the accumulator registers are not applied for the MAC instructions, the accumulator registers also can be used as the general purpose registers with the ARX, ARH and ARL mapping to R5, R6, and R7.

An initial value of the stack pointer SP is the last bit address in the internal XRAM 72 when the data of the internal XRAM 72 does not exceed 4 K bytes. For example, if the data of the internal XRAM 72 is 2 K bytes and the last bit address is 07FE, the address 07FE indicates the initial value of the stack pointer SP.

Furthermore, the frame pointer FP is used in a C compiler to allocate a designated address for local variables, so as to speed up the function call and return performance.

Moreover, the present invention also provides several special function registers, which include a system option control register (SOCR), a program status register (PSR), and a stack overflow/underflow register (STOVUN).

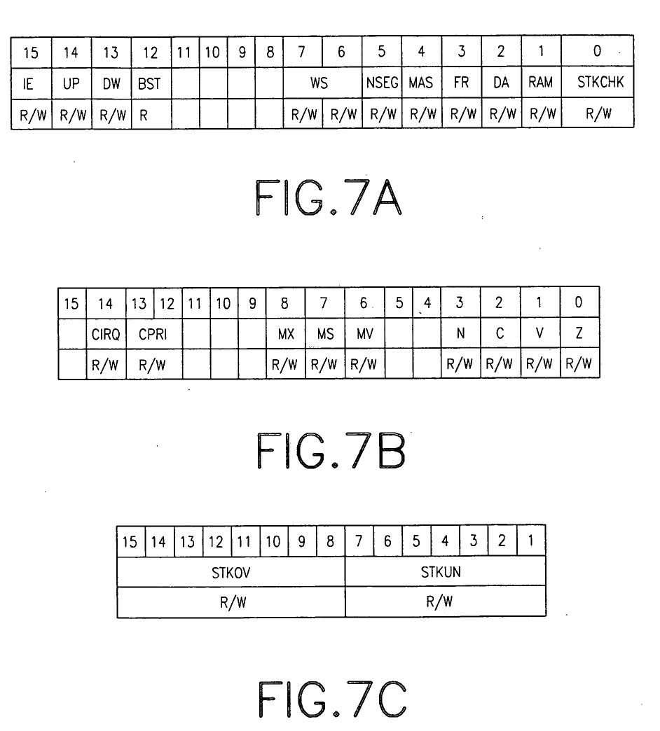

1. The system option control register (SOCR): referring to FIG. 7A, an initial value of the system option control register is 0x000. Each bit of the register is interpreted as follows.

STKCHK: set this bit to automatically check the stack pointer overflow/underflow.

RAM: set an initial address of 0x0000 for interrupt/trap vectors.

FR: used to set a fraction operation for MUL (multiplication) and MAC instructions. If the FR bit is set, a result of the multiplication operation will be shifted to the left by one bit.

MAS: if the MAS bit is set, a saturation mode will start automatically. When the accumulator is in the saturation mode and also a 32-bit overflow occurs, the accumulator will hold a maximum negative value of FF80000000 or a maximum positive value of 007FFFFFFF according to an overflow direction.

NSEG: the NSEG bit can set to restrict a program code to be smaller than 64 K byte.

WS: this bit is used to set a wait-state number of the external ROM/RAM.

DW (Disable Watch Dog Timer): if this bit is set, a watchdog timer is canceled.

UP: to cancel the protected registers. Some data of registers are write-protect to avoid writing. If desiring to change the write-protect setting of the registers, the write-protect setting has to be canceled first.

IE: an Interrupt Enable bit.

2. Program status register (PSR): referring to FIG. 7B, an initial value of the program status register is 0X0000. Each bit of the register is interpreted as follows.

Z: represents a zero flag.

V: represents an overflow flag.

C: represents a carry flag.

N: represents a negative flag.

MV: represents an MAC (Multiply and Accumulate) overflow flag, which indicates the overflow of 40 bits excess in the MAC operation.

MS: an MAC saturation flag, which indicates the saturation in the MAC operation.

CPRI: priority information of the current process.

CIRQ: this bit will be automatically set to 1 by hardware when entering into interrupt service routine or exception handling routine. If CIRQ is 1, the other interrupt requests will be allowed only when the PRI of that interrupt is larger than CPRI. If CIRQ is 0, the other interrupt requests will be allowed when PRI of that interrupt is equal or larger than CPRI.

3. Stack overflow/underflow register (STOVUN): referring to FIG. 7C, an initial value of the program status register is 0X01FF.

The processor of the present invention allows execution of a stack operation in any location of the internal ROM/RAM by changing the stack pointer SP to designate a stack address.

The stack overflow/underflow register includes two 8-bit registers: STKOV and STKUN. An addressing manner of the stack overflow/underflow register can be up to 4 K, and a minimum storage unit is 16 bytes, which indicates that a minimum stack capacity is 16 bytes. An upper limit of the stack is STKUN*16, and a lower limit of the stack is STKOV*16. An initial value of the stack pointer can be set as STKUN*16. A stack underflow occurs when the stack pointer is higher than STKUN*16. On the other hand, a stack overflow occurs when the stack pointer is lower than STKOV*16.

Third: MAC Unit and Address Generation Unit (AGU):

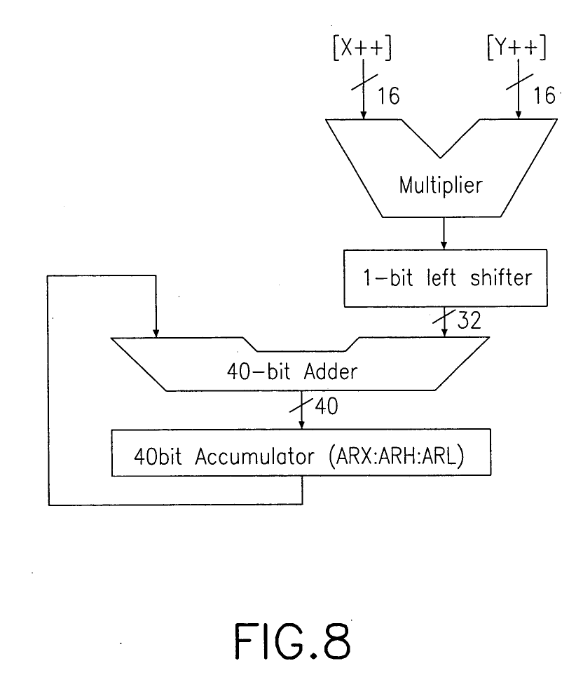

MAC Unit: referring to FIG. 8, the MAC unit is capable of improving the performance of digital signal processing algorithms to execute multiply and accumulate. The MAC operation does multiply and accumulate operation on two sequences of 16-bit data in a single cycle with each data pointed by X and Y registers. A result is outputted to a 40-bit adder via a 1-bit left shifter. Then the result is added up with a previous result in the adder. The result of MAC operation is placed in ARX: ARH: ARL.

Address Generation Unit (AGU): as shown in the FIG. 1, the present invention has two address generation units capable of generating two addresses simultaneously: the X address generator 20 and the Y address generator 22. Thus, the present invention can access two memory operands by providing two different address instructions in one cycle. The X address generator 20 can address all the memory space of the present invention but the Y address generator 22 is limited to the internal YRAM address range.

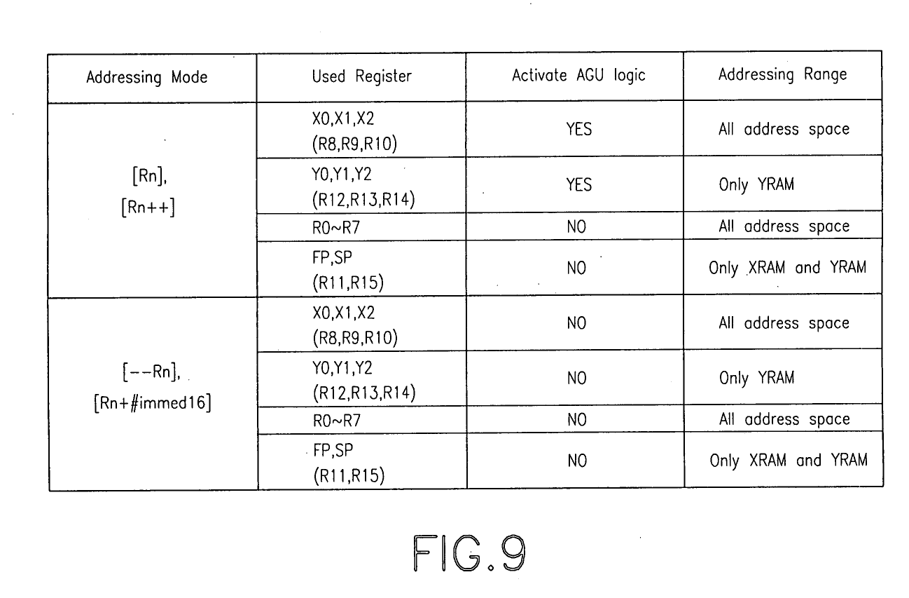

Both the X address generator 20 and the Y address generator 22 support three addressing modes: a linear addressing mode, a circular buffer addressing mode, and a bit-reversal addressing mode. Referring to FIG. 9, any instruction that accesses [Xn] or [Yn] will activate an address generation logic, but some addressing modes like [Xn+#immed16] and [--Rn] will not activate the address generation logic.

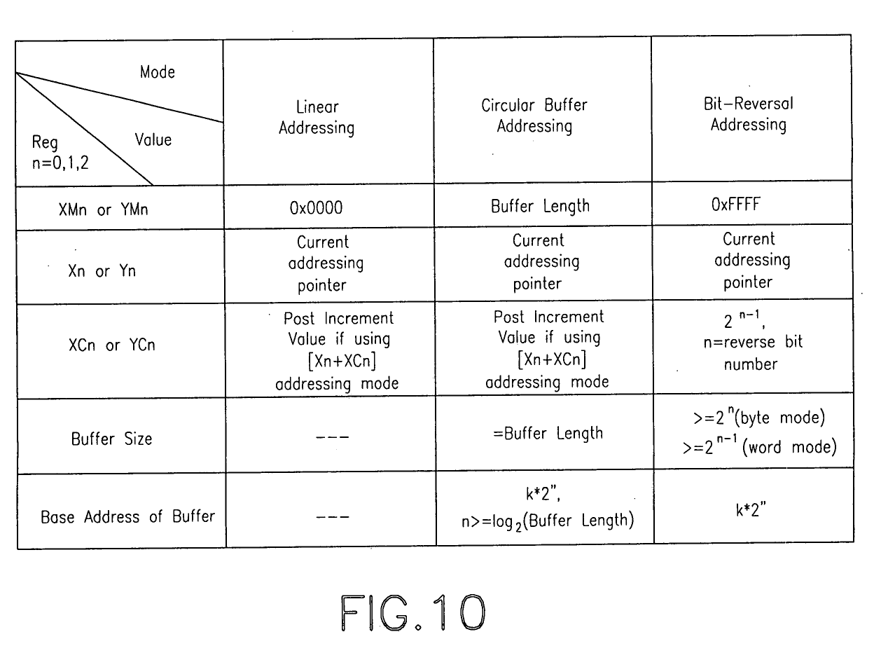

There are three sets of addressing registers for both of the X address generator 20 and the Y address generator 22. [X0, XM0, XC0], [X1, XM1, XC1] and [X2, XM2, XC2] are the three sets of the addressing registers in the X address generator 20. [Y0, YM0, YC0], [Y1, YM1, YC1] and [Y2, YM2, YC2] are the three sets of the addressing registers in the Y address generator 22. These addressing registers support the above-mentioned three addressing modes, and these addressing modes can be distinguished by the XMn or YMn register. Referring to FIG. 10, if the value of XMn or YMn is 0x0000, the addressing mode is linear addressing. If the value of XMn or YMn is 0xFFFF, the addressing mode is bit-reversal addressing. The other value of XMn or YMn will represent the circular buffer addressing mode.

1. Linear Addressing:

The linear addressing is the normal addressing mode supporting the MAC instruction. For example,

| | |
|---|---|
| MAC | [X0++], [Y0++] |

This instruction multiplies and accumulates two linear array elements each pointed by X0 and Y0. After the multiply-accumulate operation, both X0 and Y0 are incremented by 2. If it is wished to apply this operation to all elements (assume the array size is 256) of these two linear arrays, the following codes can be written:

| | |
|---|---|
| REP | 255 |
| MAC | [X0++], [Y0++] |

Some DSP algorithms (for example, FIR algorithm) have fixed coefficients and moving data. After each multiply-accumulate operation, the current data overwrites the previous data. The present invention assumes the data is pointed by the X address generator 20 and the coefficient is pointed by the Y address generator 22. For example,

| | |
|---|---|
| MAC.m | [X0++], [Y0++] |

This instruction will first fetch the data pointed by X0 and the coefficient pointed by Y0. After multiplying these two elements and accumulating the result into the accumulator, the processor of the present invention will keep [X0] data and overwrite to the address (X0−1).

2. Circular Buffer Addressing:

The circular buffer addressing is used to speed up some DSP algorithms with repeated MAC operations. For example, if it is desired to declare a 16-word circular buffer, the following instruction can be used:

Label0: .CIRCBUF 0x10.

The instruction defines the 16-word circular buffer that the base start address should be k*2⁵.

This instruction will allocate 16 words (32 bytes) in ram. The base address of the circular buffer will be automatically allocated to an address of k*(2ⁿ), where 2ⁿ>=0x20 and k is any integer number. The upper bound of the buffer will be k*(2ⁿ)+0x20−1.

For example, if the start address is the 5th word in the buffer, the following instruction is used to perform MAC operations on the circular buffer Label0.

MOV X0, #Label0+10; (5 word*2=10 bytes).

MOV XM0, #0x20; the buffer length is 16 words (0x20 bytes).

REP #0x2D; proceed 0x2E times of the next instruction.

MAC.uu [X0++], [Y0++]

These codes will perform 0x2E times of MAC operations on the circular buffer Label0 starting from #Label+10 address. After each operation, the X0 will be incremented by 2 automatically. When X0>=#Label0+0x20, X0 will be wrapped around to #Label0+(X0−(#Label0+0x20)).

3. Bit Reversal Addressing:

The bit-reverse addressing logic is mainly used in FFT algorithms. This mode is available only on addresses generated from the three sets of addressing registers for both AGU and the value of XMn or YMn is 0xFFFF.

The bit-reversed address is derived from reversing the bit order of an address. For example, if the address of a 32-word buffer is as the form k9k8k7k6k5k4k3k2k1k0b5b4b3b2b1b0. The bit-reversed address will be the form k9k8k7k6k5k4k3k2k1k0b0b1b2b3b4b5. Note that the six least significant bits order is reversed.

Fourth: Barrel Shifter:

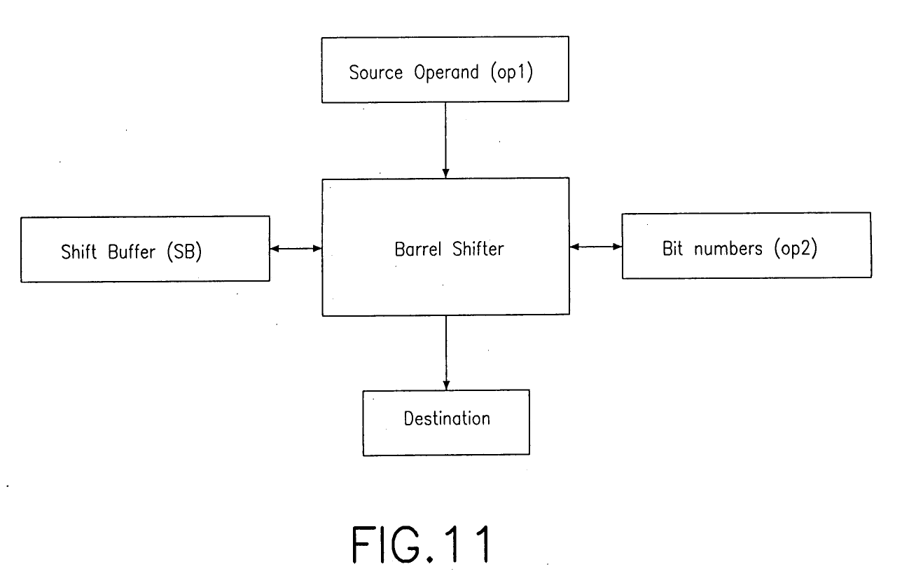

Referring to FIG. 11, the barrel shifter of the present invention is capable of shifting any bit of a register operand or a memory operand in one cycle. This means the shift operation performs read-shift-write to the same register/memory address. There are seven types of operations that use the barrel shifter, i.e., SR, SL, ROR, ROL, ASR, SLOSB, and SROSB.

Fifth: Interrupt and Exception Handling:

There are three types of event sources that will make the processor of the present invention suspend current execution and branch to service routine. The 7 first event source is called “interrupt” which is generated from the peripherals, e.gs. timers, I/O ports, serial interfaces, A/D converters, etc. The second event source is exception which is generated during the program execution. Exception may not be in the expectation handling of a programmer when writing the program. For example, an invalid instruction, an invalid address, stack overflow, to divide by zero, etc. The third event source is explicitly written in a program as an instruction form. Users can use “Trap” instructions to generate software interrupt. The instruction will be processed in the same manner as occurs with hardware interrupt. Users may also set a bit in Interrupt Control Register (ICR) to make an interrupt request as hardware made to generate interrupt.

The processor of the present invention can support up to 32 interrupt sources. There are three sets of registers to control the interrupt behavior. Interrupt mask registers are used to enable/disable interrupts. Interrupt pending registers are used to indicate the request status of interrupts. Interrupt level registers are used to prioritize the interrupts.

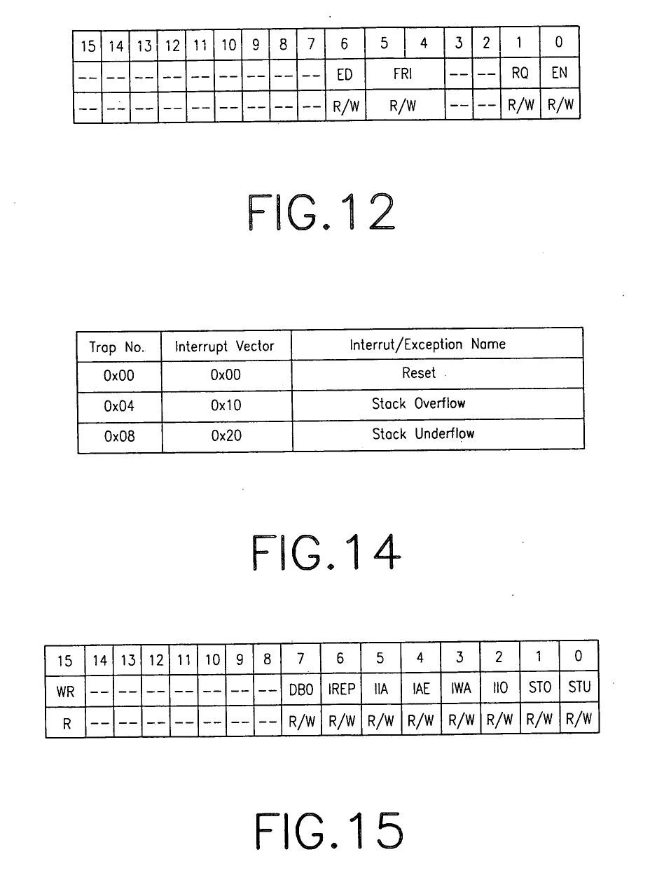

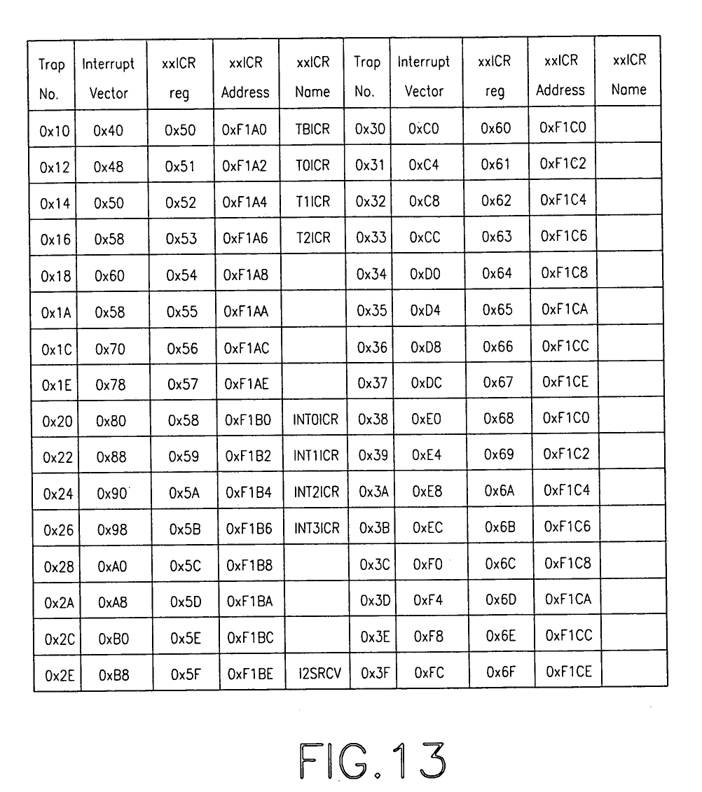

Referring to FIG. 12, a table of a plurality of the interrupt control registers (xxICR) of the present invention is shown. Moreover, FIG. 13 shows a table of addresses of the interrupt control registers and interrupt-vectors of the present invention. A bit description of the interrupt control registers is as follows.

EN: Interrupt Enable. Set this bit enabling the interrupt request to be processed.

RQ: Interrupt Request. This bit indicates the respective interrupt request has occurred and is pending. The bit is set by hardware if the interrupt occurs and will be cleared automatically by hardware when entering the respective interrupt service routine or the interrupt is processed by the data transfer unit 51. These two registers can be read or written by software.

ED: Enable DTU Processing. This bit enables the DTU 51 to process the interrupt request and transfer the data pointed by SRCPx to destination address pointed by DSTPx. If the ED bit is set, the PRI will represent the DTU channel used by this interrupt.

PRI: Interrupt Priority. The present invention supports four levels of interrupt priority. The value of PRI is 0˜3. A bigger number is represented as higher priority. When an interrupt request occurs, the present invention will compare the PRI with CPRI in the PSR register. If PRI is higher than CPRI, the interrupt request is accepted and the current process will be suspended. If PRI is not higher then CPRI, the interrupt request will be pending and kept on set. If there are many interrupt-requests coming in the same cycle, the priority of them will be compared and let a highest priority interrupt to be serviced.

Exception: the exception is generated while executing a program and some events occur. The exception handling mechanism can help programmers to create more robust program codes and can help to debug the program. FIG. 14 shows a table of the exceptions supported by the present invention. FIG. 15 shows a table of an exception register (EXR) of the present invention. The present invention supports the following exceptions:

STU: Stack Underflow.

STO: Stack Overflow.

IIO: Invalid instruction or error format of operands.

IWA: Invalid word access address, which fetches the operands from the invalid word address.

IAE: Invalid Address Error, which fetches an undefined address.

IIA: Invalid Instruction Address.

IREP: Illegal Repeated Instruction.

DB0: Divide By Zero.

The exception operation is similar to the interrupt operation, but there are some differences. Firstly, when exception happens, the current instruction (the instruction in decode stage) address will be pushed into the stack, which is different with the interrupt operation. The interrupt operation will push the next instruction (not yet decoded instruction) address into the stack. Second, before entering the exception routine, the CIRQ bit in the PSR register will be set to 1 and the CPRI will be set to 11 (the highest priority). The interrupt operation will copy the PRI bits from ICR to PSR whereby it can be known that the exceptions have higher priority than all interrupts. The priority between different exceptions depends on the exception vector. A lower value of the vector represents that the exception has the higher priority.

Sixth: Data Transfer Unit (DTU):

The data transfer unit 51 is included in the advanced memory parallelism bus (AMPB) 50. The data transfer unit 51 is capable of catching an interrupt and transferring a word or a byte from a preset source memory address to a preset destination memory address in one cycle. The data transfer unit 51 can automatically increment a source address pointer or destination address pointer after transferring the data.

There are 4 DTU channels in the DTU 51 which means at most 4 different interrupts can be assigned to the DTU 51. When an interrupt is assigned to the DTU 51 and the DTU channel's count is not zero, the interrupt service routine will not be activated. The interrupt request will cause the DTU channel n to get a word or a byte data located in the address stored in SRCPn. Then the DTU channel n stores that data into the address stored in DSTPn.

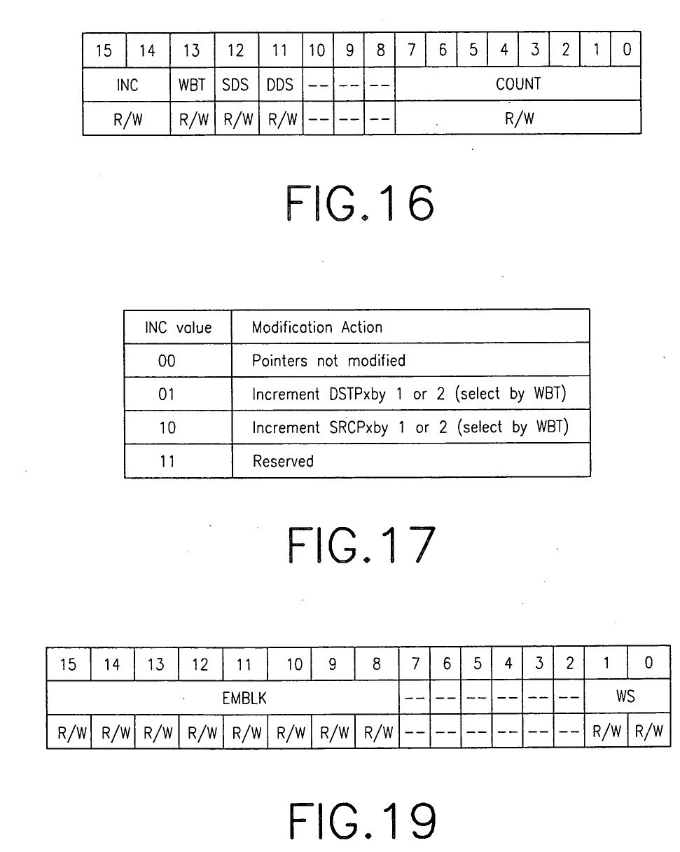

Referring to FIG. 16, a table of a data transfer unit control register DTUCx of the present invention is shown. After transferring the data, the COUNT in the DTU control register will be decremented by 1. If the COUNT becomes zero after decrementation, a real interrupt will be activated and cause the interrupt service routine to be executed. The priority of this interrupt will be the highest priority.

To enable the DTU 51, the ED flag in interrupt control register xxICR should be set and the PRI field in xxICR should be set to the channel number of the DTU 51. The following section describes fields of the DTU control register DTUCx

COUNT: counts DTU transfers.

WBT: Word/Byte transfer selection. Cleared to select word transfer mode and set it to select byte transfer mode.

SDS: if the SDS field is set, SRCPx is enabled to combine DS0/DS1 to calculate and generate a source address data. If the SDS field is not set, the source address equals to SRCPx.

DDS: if the DDS field is set, DSTPx is enabled to combine DS0/DS1 to calculate and generate a source address data. If the DDS field is not set, the source address equals to DSTPx.

INC: Increment Control. To control the modification of SRCPx and DSTPx. Referring to FIG. 17, a contrast table of the INC field of the data transfer unit-control register DTUCx of the present invention is shown. The INC field is made of two bytes. 00 represents that pointers are not modified. 01 represents that the DSTPx is incremented by 1 or 2 (select by WBT). 10 represents that the SRCPx is incremented by 1 or 2 (select by WBT). 11 represents reserved.

The COUNT field in DTUCx will be decremented by 1 after every DTU transfer. When the count field becomes 0, an interrupt will happen and enter interrupt service routine. The interrupt can process the transferred data, adjust the source/destination pointer and set the COUNT field again. After returning from the interrupt service routine, the DTU 51 will be activated again and continue to transfer data when the interrupt event occurs.

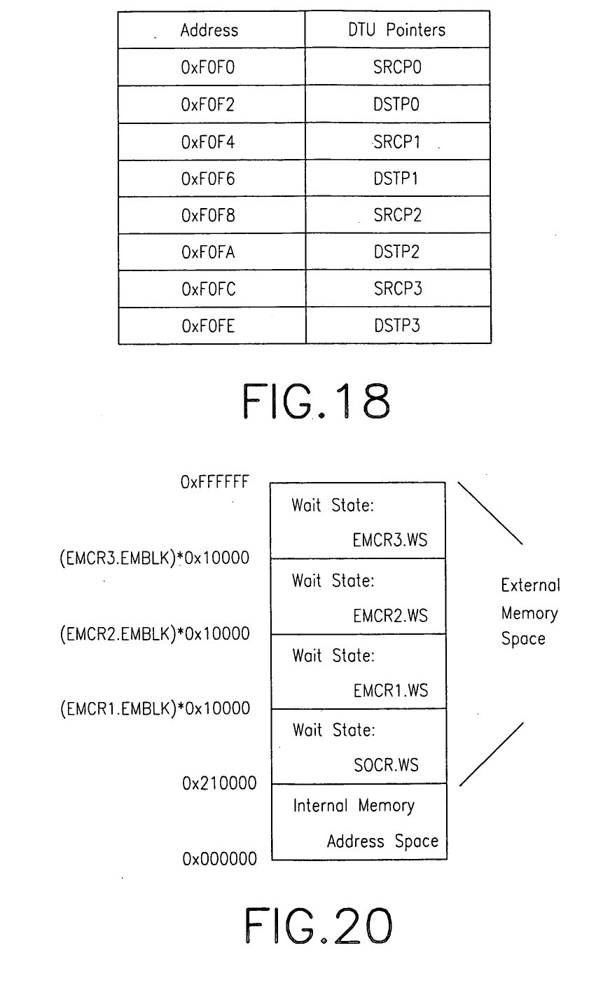

Referring to FIG. 18, an address vs. pointer table used by the data transfer unit 51 of the present invention is shown. When an interrupt is accepted by the DTU 51, the DTU 51 will read SRCPn as source address and DSTPn as destination address in parallel.

Seventh: External Memory Interface:

The external memory interface for the external ROM/RAM can support standard ROM, EEPROM, SRAM, NOR Flash Memory, and NAND Flash Memory. The connected external memory can be addressed to be larger than 16 MB. Because a dynamic external memory control register (EMCR) is used, the EMCR can control the start address of any memory. Currently three EMCRs are used.

Referring to FIG. 19, a table of the external memory control register (EMCR) of the present invention is shown. An EMBLK (external memory block address) field is used to separate an external memory space and control a chip select active/inactive function for an external memory to read/write. The minimum unit of a block is 64 K byes. A WS field is used to insert the wait state for read/write control signals. A maximum wait state is 3 system clock cycles, and a maximum read/write cycle is 4 system clocks.

Referring to FIG. 20, it shows how the external memory space is separated into 4 segments, and the boundary addresses of each segment. The EMBLK of EMCR1 defines the upper bound of the first segment. The lower bound of the first segment is the absolute address 0x30000. The wait state of the first segment is defined in the default wait state field (WS) in an SOCR register.

The second segment address boundary is defined with (EMCR1.EMBLK)*0x10000 as the lower boundary and (EMCR2.EMBLK)*0x10000 as the upper bound address. The wait state of the second segment is EMCR1.WS. The third segment address boundary and the fourth segment address boundary are thereby analogized.

Eighth: Clock Generation and Operation Modes

The present invention provides three operation modes: a normal operation mode, an idle mode and a sleep mode. The normal operation mode operates with a system clock. A CLKSEL field of a clock control register (CLKCON) determines the frequency of the system clock. The system clock is in an off state in the idle mode and the sleep mode.

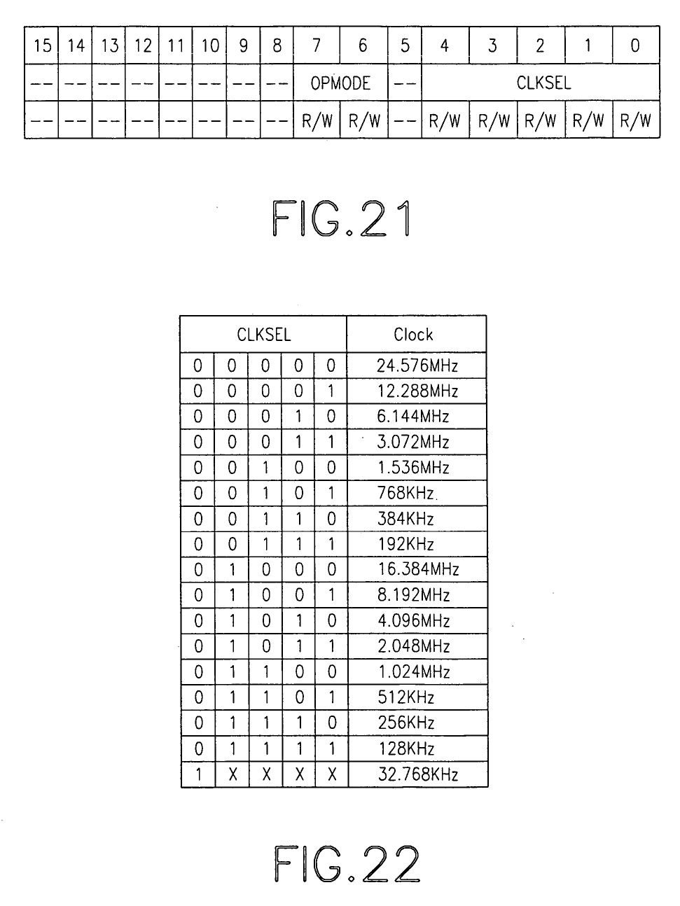

Referring to FIG. 21, a table of the clock control register (CLKCON) of the present invention is shown. The CLKSEL field made up by five bits is used to set up the frequency of the system clock. FIG. 22 shows a system clock table that the clock control register (CLKCON) can set the frequency between 32.768 KHz to 24.576 MHz. The CLKCON is a protected register, which means the SOCR.UP bit must be set in order to write new value into this register. After writing to CLKCON, the SOCR.UP should be cleared.

Ninth: Timers:

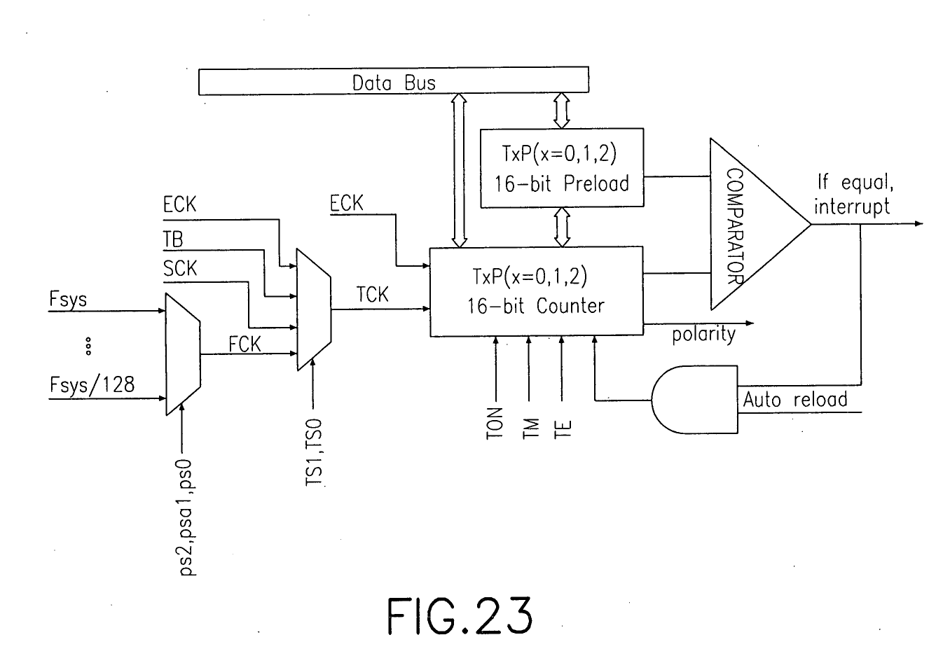

There are three Timers and one Time Base Clock (TB) in the present invention. Each Timer has one control register (TxC), one preload register (TxP) and one timer counter register (Tx). FIG. 23 shows a structure block diagram of a timer of the present invention. A clock source of Timer (Fsys) that inputs to the timer is selected from the CLKSEL field of the CLKCON register.

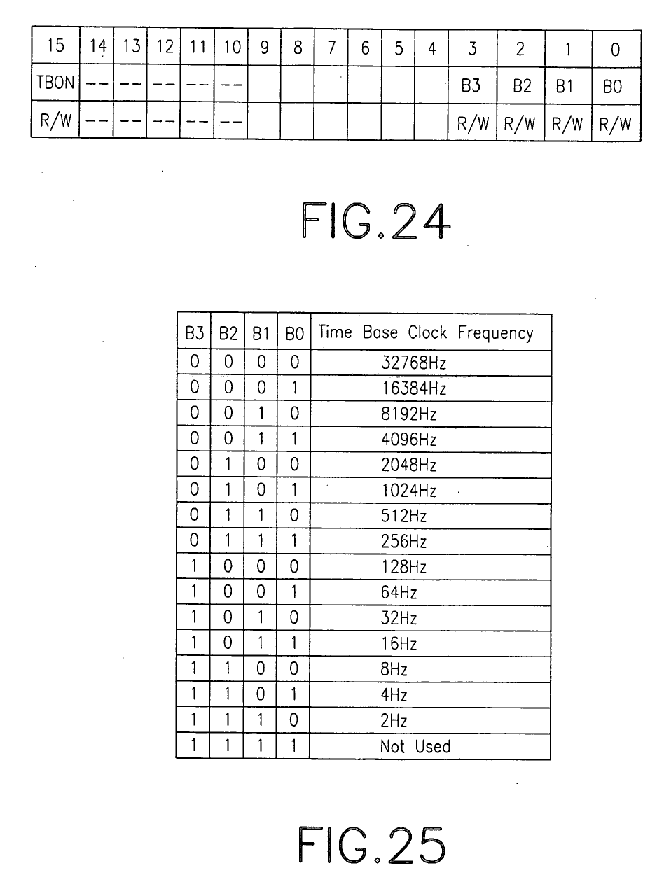

The Time Base Clock is a simple timer that generates a 2 Hz˜32768 Hz interrupt signal. There is a time base control register (TBC) to control the frequency of the time base clock. FIG. 24 shows a table of a time base control register (TBC) of the present invention. FIG. 25 shows a time base clock frequency table for four bits of B0˜B3 of the TBC in FIG. 24.

Tenth: I/O Ports and External Interrupts:

The present invention provides 64 I/O (input/output) pins, which are categorized into four groups: P0.0˜P0.15, P1.0˜P1.15, P2.0˜P2.15, and P3.0˜P3.15. Four of the I/O pins are used as external interrupt pins: P0.15, P0.14, P0.13 and P0.12 as INT0, INT1, INT2 and INT3.

As in the foresaid description, the present invention provides the pipelined architecture capable of executing the single instruction in the single cycle. The detailed pipeline operation is described as follows.

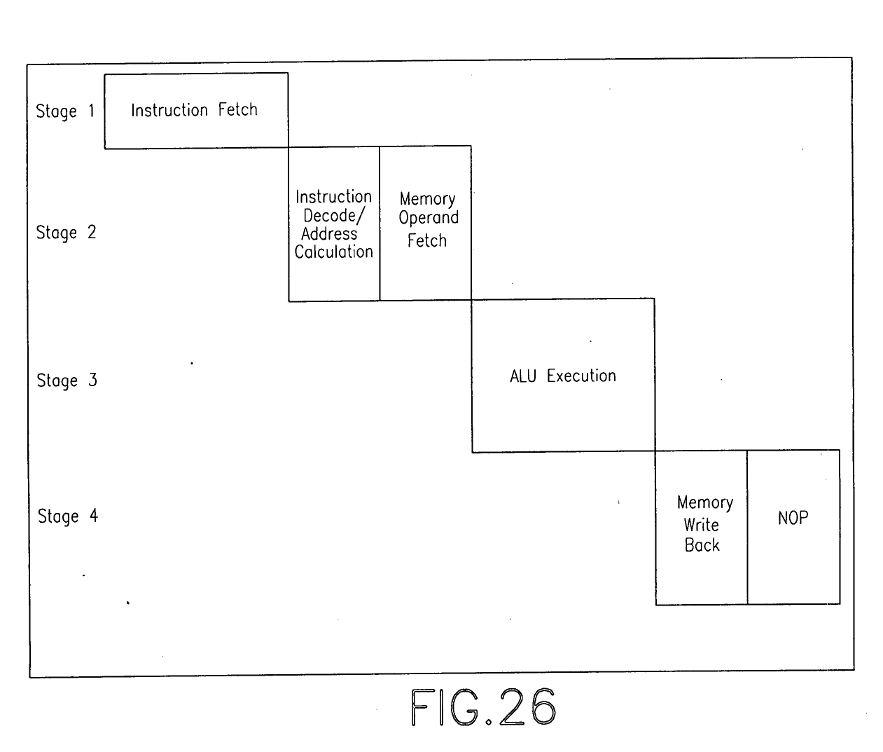

Referring to FIG. 26, a diagram of the pipeline operation of the present invention is shown. The pipeline operation includes four stages of fetching the instruction, decoding the instruction, executing the instruction and writing back to the memory. Note that the read/write actions are executed in the different phases. The high performance 4-stage pipelined architecture and a powerful instruction set (referring to the appendix) achieve the best parallelism, so as to provide the optimal operating performance. The four phases are described as follows:

The first phase: fetching the instruction from a RAM or an instruction buffer.

The second phase: decoding the instruction and also simultaneously computing an operand location to fetch the operand from the memory if required. If the operand is stored in an address pointed by a register, which is an indirect addressing, the register is read to compute the location of the operand. In some addressing modes, the register is allowed to execute a post increment or pre decrement.

The third phase: the arithmetic unit 10 performing the calculation on the operand according to the instruction.

The fourth phase: a calculation result of the third phase is written to a target memory address.

Branch Instruction Processing:

The processor of the present invention includes three types of transfer instructions. The first type of the transfer instructions is an unconditional transfer instruction such as SJMP and SCALL. The second type of the transfer instructions is a conditional transfer instruction such as SJMP, SCALL and JB. The third type of the transfer instructions is a special repeat operation to execute a loop in zero overhead.

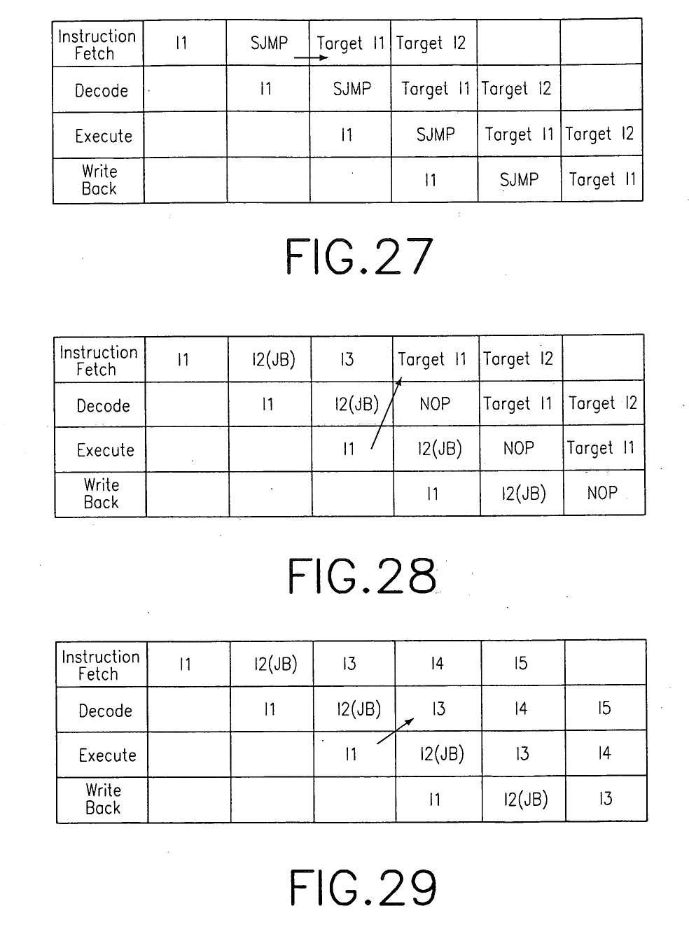

Referring to FIG. 27, a table of a pipeline operation of the unconditional transfer instruction of the present invention is shown. The unconditional transfer instruction can be decoded in advance by the instruction decoder/control unit 62. A next address is then generated in the first stage of the transfer instruction. There is no overhead in the process of pipeline operation.

Referring to FIG. 28, a table of the pipeline operation of the conditional transfer instruction of the present invention is shown. The conditional transfer instruction must check condition codes and a PSW (program status word) register to determine if a transfer action has been executed. FIG. 28 shows that I1 fetches target instruction codes after the “execute” stage when executing the conditional transfer action.

The instruction fetch unit 60 immediately fetches the next instruction after fetching the conditional transfer instruction. Therefore, the next instruction will be decoded directly if there is no transfer action, as shown in FIG. 29.

Referring to the appendix “Instruction set”, the instruction set of the processor of the present invention is shown. The instruction set can be separated as arithmetic, shift/rotate, bit operation, branch, comparison, data movement and MISC instructions. The processor of the present invention can achieve the best performance by the original and novel instruction set and the above-mentioned hardware architecture.

To conclude, the processor of the present invention includes features as follows:

First, high performance 4-stage pipelined architecture capable of executing the MCU or a DSP instruction in a single cycle.

Second, the single cycle MAC instruction execution with data movement ability can optimize the FIR algorithm.

Third, bit reversal function is available to optimize the FFT algorithm.

Fourth, repeat instruction can repeat the single instruction many times, so as to effectively simplify the instruction composing.

Fifth, the automatic stack overflow/underflow detection can avoid complicated stack check and support unlimited stack structure.

Sixth, the present invention supports Word, Byte and Bit operations to more powerfully meet MCU control.

Therefore, the integrated data processor of the present invention includes novelty and obviously improves the performance of the conventional data processor.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An integrated data processor comprising:
an arithmetic unit as a core unit for performing data calculation, wherein the arithmetic unit is connected to a common data bus and a Y data bus, wherein the common data bus is connected to an X address generator, a data fetch unit and a register unit, and wherein the Y data bus is connected to an internal Y RAM;
an advanced memory parallelism bus (AMPB) connected to the data fetch unit and an instruction fetch unit, wherein the AMPB is connected to an internal program ROM/FLASH, an internal X RAM, an external ROM/RAM and a plurality of peripherals, wherein the AMPB can use a pipeline operation manner to synchronously process data transmission and fetch an instruction to enhance a parallel operation, wherein the AMPB further comprises a data transfer unit and an interrupt controller, wherein the interrupt controller takes charge to handle when an interrupt is requested; and
a Y address generator connected to the register unit and the internal Y RAM.

2. The integrated data processor as claimed in claim 1, wherein the pipeline operation of the advanced memory parallelism bus (AMPB) comprises four phases of fetching the instruction, decoding the instruction, executing the instruction and writing back to the memory, wherein read/write actions are executed in the different phases.

3. The integrated data processor as claimed in claim 2, wherein the four phases comprise:
a first phase: fetching the instruction from a RAM or an instruction buffer;
a second phase: decoding the instruction and also can simultaneously compute an operand location to fetch the operand from the memory;
a third phase: the arithmetic unit performing the calculation on the operand according to the instruction; and
a fourth phase: a calculation result of the third phase is written to a target memory address.

4. The integrated data processor as claimed in claim 1, wherein the instruction fetch unit is connected to an instruction decoder/control unit, wherein the instruction decoder/control unit decodes the coded instruction fetched by the instruction fetch unit and generates a pipeline control instruction.

5. The integrated data processor as claimed in claim 1, wherein the arithmetic unit can fetch two operands from the internal X RAM and the internal Y RAM within a cycle to provide for a multiply-and-accumulate (MAC) calculation.

6. The integrated data processor as claimed in claim 5, wherein the X address generator and the Y address generator can generate two addresses simultaneously, so as to provide for the MAC calculation.

7. The integrated data processor as claimed in claim 1, wherein the X address generator and the Y address generator support a linear addressing and a circular buffer.

8. The integrated data processor as claimed in claim 7, wherein the X address generator further supports a bit reversal addressing.

9. The integrated data processor as claimed in claim 1, wherein the register unit comprises a plurality of general-purpose registers, a plurality of accumulator registers, a plurality of index registers, a frame pointer and a stack pointer.

10. The integrated data processor as claimed in claim 1, wherein the register unit comprises a plurality of special function registers, wherein the special function registers comprise a system option control register (SOCR), a program status register (PSR), and a stack overflow/underflow register (STOVUN).

11. The integrated data processor as claimed in claim 1, wherein the arithmetic unit comprises a MAC unit, wherein the MAC unit completes a multiply-and-accumulate calculation in a single cycle, wherein the MAC unit receives two sets of 16-bit data indicated by the register unit to execute a multiplication calculation in the single cycle, and then outputs a result to a 1-bit shift shifter to execute a shift operation, and then outputs the result to a 40-bit adder to add up with a previous result from accumulator.

12. The integrated data processor as claimed in claim 1, wherein the interrupt controller comprises a plurality of interrupt control registers, wherein the interrupt control registers can set to interrupt pending, set an interrupt level and a priority order of an interrupt request.

13. The integrated data processor as claimed in claim 1, wherein the data transfer unit comprises four channels, wherein each channel is corresponding to a data transfer unit-control register.

14. The integrated data processor as claimed in claim 1, wherein an external memory control register (EMCR) of an external memory interface for the external ROM/RAM comprises an EMBLK (external memory block address) field used to separate an external memory space and control a chip select active/inactive function for an external memory to read/write, wherein a minimum unit of a block is 64 K byes.

15. The integrated data processor as claimed in claim 14, wherein a plurality of dynamic external memory control registers are used to control the start address of the external ROM/RAM.
